(19) United States
(12) Patent Application Publication
(10) Pub. No.: US 2026/0287120 A1
(43) Pub. Date: Sep. 24, 2026

(54) FUEL SYSTEM FOR SUPPLYING AN AIRCRAFT WITH HYDROGEN, METHOD AND AIRCRAFT

(71) Applicant: MTU Aero Engines AG, München (DE)

(72) Inventors: Anja MAROSKY, München (DE); Thomas SCHERER, München (DE); Stefan WEILAND, Augsburg (DE)

(73) Assignee: MTU Aero Engines AG, München (DE)

(21) Appl. No.: 19/475,600

(22) PCT Filed: Apr. 10, 2024
(86) PCT No.: PCT/EP2024/059679

§ 371 Date: Oct. 15, 2025

(30) Foreign Application Priority Data
Apr. 19, 2023 (DE) 10 2023 109 931.0

(51) Int. Cl. F17C 7/02; B64D 37/00; B64D 37/06; B64D 37/20; B64D 37/30; B64D 37/32; B64D 45/00

(52) U.S. Cl. CPC F17C 7/02; B64D 37/005; B64D 37/06; B64D 37/20; B64D 37/30; B64D 37/32; B64D 45/00; B64D 2045/0085; F17C 2201/0109; F17C 2203/0391; F17C 2205/0134; F17C 2205/0326; F17C 2221/012; F17C 2223/0161; F17C 2250/0443; F17C 2265/066; F17C 2270/0189

(57) ABSTRACT

The invention pertains to a fuel system for supplying an aircraft with hydrogen. The fuel system comprises a first inner tank and a separate, second inner tank, each for storing hydrogen, and an outer tank, which surrounds the inner tanks. The first inner tank and the second inner tank separately from each other are fluidically connected to at least one first supply device for supplying the aircraft with hydrogen. The invention further pertains to an aircraft with a fuel system, and a method.

### BACKGROUND OF THE INVENTION

The invention pertains to a fuel system for supplying an aircraft with hydrogen. The fuel system comprises a first inner tank for storing hydrogen and an external tank. The invention further pertains to an aircraft with a fuel system, and a related method.

In modern aviation, hydrogen is becoming increasingly attractive as a fuel for aircraft drives in many respects. The hydrogen is carried in tanks, whose requirements differ significantly from conventional kerosene tanks. Compared to kerosene, the volume of liquid hydrogen is 4 times higher with a weight 2.8 times lower. Consequently, this can entail different requirements for the design of the fuel tanks for aviation applications.

DE 10 2007 025 217 A1 describes a device and method for storing hydrogen for an aircraft, in which the outer tank is connected to the inner tank in such a way that hydrogen from the outer tank can be fed to the inner tank to increase its efficiency.

DE 10 2014 107 316 A1 shows a tank system for cryogenic storage of hydrogen, which can be integrated into the load-bearing primary structure of an aircraft due to its structure.

For the use of a hydrogen fuel system in a commercial aviation application, applicable regulatory requirements must be met, which are particularly demanding with regard to safety requirements in the event of a failure. In particular, systems must be designed with redundancy and have a correspondingly robust design. However, installation space in an aircraft is limited. Furthermore, unlike a kerosene fuel system, the hydrogen tanks cannot be easily integrated into the wing.

### SUMMARY OF THE INVENTION

The invention addresses the problem of providing a fuel system for supplying an aircraft with hydrogen, which minimizes the probability of failure with optimal use of installation space.

The problem is solved by the features of the independent patent claims. Advantageous developments of the invention are described by the dependent patent claims, the following description and the figures.

By an aspect of the invention, a fuel system for supplying an aircraft with hydrogen is provided. The fuel system comprises at least one first inner tank for storing hydrogen and at least one outer tank. The fuel system particularly comprises a second inner tank for storage of hydrogen, which is fluidically separated from the first inner tank, wherein the first inner tank and the second inner tank are stored inside the outer tank, and wherein the first inner tank and the second inner tank are each fluidically connected separately from one another to a first supply device of the fuel system for supplying the aircraft with hydrogen.

This dual tank arrangement of the fuel system according to the invention can efficiently utilize the installation space of the aircraft. In particular, by the common integration of the two separate inner tanks in a common outer tank another outer tank can advantageously be saved. In addition to installation space, the fuel system according to the invention can save material and weight, which can advantageously contribute to the efficiency of the entire aircraft.

At the same time, the separation of the two inner tanks advantageously guarantees a dual-channel fuel supply-in the event of a failure of one inner tank, the other inner tank guarantees at least half the range of the aircraft. This redundant system can ensure particularly high safety of the fuel system and thus of the aircraft. In particular, in the event of a loss or disruption of one inner tank, the other inner tank is still fully functional, so that in the event of a failure only the range is reduced.

The fuel system can also comprise further components necessary for supplying the aircraft. The aircraft can be, for example, a conventional airplane, a rotary wing aircraft, an airship or the like, which uses the hydrogen, in particular, as fuel or propellant to drive one or more main, auxiliary or secondary engines. The drive can be, in particular, a hydrogen combustion engine, a gas turbine, or a fuel cell with a downstream electric motor.

The first and the second inner tank, hereinafter also referred to as inner tanks, are particularly designed and configured to store the hydrogen, taking into account its specific physical conditions. In particular, the inner tanks can withstand an overpressure inside the tank under operating conditions. Furthermore, a third or many more inner tanks can also be provided, for which the preceding and following description applies accordingly.

The first inner tank can be formed identically or differently to the second inner tank. The inner tanks are formed or can be formed separately from one another. In other words, the inner tanks are not directly or indirectly fluidically connected to one another. Furthermore, the inner tanks can be formed structurally separated from one another. However, the inner tanks may also be integrated into a common tank module with fluidic separation from one another.

The outer tank particularly encloses or surrounds the inner tanks, preferably completely. The outer tank may be preferably designed to be bulge-stable and pressure-stable. For example, the inner tanks can be stored with a distance and supported mechanically by struts or another structure from a shell of the outer tank. The outer tank can be provided, in particular necessarily, for insulation purposes for the inner tanks. The inner tanks are in particular fluidically separated from the outer tank. In other words, it is not intended that hydrogen can get from the inner tanks into the outer tank.

The first inner tank is in particular fluidically connected to the first supply device. Separately from the connection of the first inner tank to the first supply device, the second inner tank is particularly connected to the first supply device, so that hydrogen can be transported from the first inner tank or from the second inner tank to the first supply device.

A fluidic connection is understood as a connection through which a fluid can flow. In particular, hydrogen can thus flow from an inner tank to a supply device.

The two inner tanks can be formed fluidically separable from one another, which may imply that these can be fluidically connected in a special configuration, for example using a valve of the supply device or the like. The inner tanks can be formed fluidically connectable to the supply device, which may imply that these can be fluidically separated independently of one another in a special configuration.

The fuel or propellant is particularly hydrogen, preferably pure hydrogen. However, it can also, although less preferably, be understood as a hydrogen-containing or hydrogen-based fuel or a fuel, which has comparable storage properties to hydrogen.

By an embodiment, it is provided that the fuel system comprises a second supply device for supplying the aircraft with hydrogen, wherein the first inner tank and the second inner tank are fluidically connected separately to the second supply device. In other words, the first inner tank is particularly fluidically connected to the second supply device. Separately from the connection of the first inner tank to the second supply device, the second inner tank is particularly connected to the second supply device, so that hydrogen can be transported from the first inner tank or from the second inner tank to the second supply device. Thus, the malfunction of one of the two supply devices can also be intercepted by the other supply device, by each supply device being fluidically connected to both inner tanks. This redundancy advantageously increases the safe operation of the fuel system and thus of the aircraft.

The first supply device can preferably be formed such that it is separated from the second supply device.

Each supply device, also referred to as a system capsule, balance of plant, or cold box, is designed and provided to supply the aircraft with hydrogen. In particular, the supply device is designed and provided to draw hydrogen from the first and/or the second inner tank. Furthermore, the supply device can be designed and provided to perform a corresponding conditioning of the hydrogen in the first and/or second inner tank. Furthermore, the supply device can be designed and provided to control the inner tanks, in particular to control or regulate the physical conditions of the hydrogen storage.

The supply device can in particular comprise valves, safety valves, heat exchangers, pipes, control elements, regulators, circuits and the like, which can preferably be designed redundantly within a supply device.

By an advantageous embodiment, it is provided that the first inner tank is connected to the first supply device via a first channel, and is fluidically connected to the second supply device via a second channel separate from the first channel. Alternatively or additionally, it is provided that the second inner tank is connected to the first supply device via a third channel, and is fluidically connected to the second supply device via a fourth channel separate from the third channel. This advantageously and reliably realizes the separation of the inner tanks, so that a failure of one inner tank does not affect the availability of the other inner tank.

Preferably, the inner tanks can each comprise a separate connection for the respective channel, which are particularly arranged offset from each other. Accordingly, the supply devices can each comprise a separate connection for the respective channel. This advantageously ensures the fluidic separation of the inner tanks from each other.

The outer tank can accordingly comprise sealed passage openings for the channels between inner tanks and supply devices.

By an embodiment, it is provided that the first supply device comprises a first shut-off valve for fluidically separating or connecting the first channel and/or a second shut-off valve for fluidically separating or connecting the second channel, and/or the second supply device comprises a third shut-off valve for fluidically separating or connecting the third channel and/or a fourth shut-off valve for fluidically separating or connecting the fourth channel. The respective shut-off valves can be designed separately from the supply device, for example integrated in the respective channel. The shut-off valves can advantageously isolate a defective inner tank or a defective supply device, so that it does not affect functioning components.

By an embodiment, it is provided that an intermediate space between the outer tank and the first inner tank and the second inner tank is evacuated. In other words, a technical vacuum or at least an approximation thereof prevails in the intermediate space. Advantageously, this can thermally insulate the inner tanks very effectively. The outer tank is particularly designed and can be specially provided for maintaining the vacuum. Accordingly, it can be sealed airtight. The outer tank can thus correspond to a vacuum shell (vacuum jacket). By the vacuum, a particularly effective insulation for the inner tanks can be provided.

By an embodiment, it is provided that the first inner tank and/or the second inner tank comprise a first insulation layer. The insulation layer is particularly provided to insulate the respective inner tank thermally, so that a temperature and/or a pressure of the hydrogen can advantageously be maintained at a certain level. The insulation layer may be of various designs, in particular using appropriate insulating material. Preferably, the insulation layer can comprise, in connection with the surrounding vacuum, a superinsulation, also known as Multilayer Insulation (MLI). This can consist of a few to several dozen layers of metal-coated plastic films, which are held apart by a suitable perforation or a mesh (spacer). MLI films hinder heat transfer by thermal radiation. Thus, the inner tanks can be insulated particularly effectively.

By an embodiment, it is provided that the outer tank comprises a second insulation layer, so that the insulation can be further improved. The second insulation layer can be arranged on the inside and/or outside of the outer tank. The insulation layer is particularly provided to insulate the respective inner tank thermally, so that a temperature and/or a pressure of the hydrogen can advantageously be maintained at a certain level. On the inside, the insulation layer can comprise an MLI in connection with the surrounding vacuum. On the outside, the outer tank can comprise a corresponding insulating material as a second insulation layer.

By an embodiment, it is provided that the first inner tank and/or the second inner tank are designed and accordingly laid out to store hydrogen cryogenically, in particular in a liquid state and at a very low temperature, for example at −253° C. In this state, the hydrogen can be stored particularly safely. In particular, the inner tanks can be designed to withstand a certain pressure of the hydrogen. This can be, for example, between 1 bar and 10 bar, or even a pressure of up to 350 bar.

By an embodiment, it is provided that the first inner tank and/or the second inner tank are designed in a modular manner. In other words, the inner tanks are not integrally mounted with the outer tank, but can be easily inserted and removed. Preferably, the outer tank can be reversibly opened, so that the first inner tank and/or the second inner tank can be exchanged. For example, the outer tank can comprise a closing mechanism for opening and closing the shell of the outer tank. This allows the inner tanks to also be advantageously inspected and maintained or removed. It is also conceivable that an emptied inner tank is replaced by a hydrogen-filled inner tank.

By an embodiment, it is provided that the first supply device and/or the second supply device are designed to extract liquid or cryogenic hydrogen from the first inner tank and/or from the second inner tank. In particular, the supply device can condition the removed hydrogen to supply the aircraft with the conditioned hydrogen. For example, the supply device can evaporate the liquid hydrogen before it is passed on.

Alternatively or additionally, the supply device can be designed to extract gaseous hydrogen from the inner tanks.

By an embodiment, it is provided that the fuel system comprises a sensor device, which is designed to detect a disruption of the first inner tank and/or the second inner tank and/or the outer tank. Preferably, the sensor device is designed to detect a disruption of the first supply device and/or the second supply device. This advantageously allows the faulty component to be identified and appropriate countermeasures to be taken, for example by closing valves. This can increase the safety of the system and the aircraft.

By a further aspect of the invention, a method for operating a fuel system according to the invention is provided. The method comprises at least the step of supplying the aircraft with hydrogen from the first inner tank in the event of a disruption of the second inner tank, or supplying the aircraft with hydrogen from the second inner tank in the event of a disruption of the first inner tank.

By an embodiment, it is provided that the method comprises at least the step of supplying the aircraft with hydrogen via the first supply device in the event of a disruption of the second supply device, or supplying the aircraft with hydrogen via the second supply device in the event of a disruption of the first supply device.

The redundant design of the respective components allows for a particularly safe operation of the fuel system and thus of the aircraft. In particular, the aircraft can advantageously be supplied with hydrogen if an inner tank as well as a fuel system experience a disruption.

The invention also includes further developments of the method according to the invention, which comprise features as already described in connection with the developments of the fuel system according to the invention. For this reason, the corresponding developments of the method according to the invention are not described again here. In particular, the fuel system is designed to execute the method according to the invention.

By a further aspect of the invention, an aircraft with at least one fuel system according to the invention is provided. The aircraft can be, for example, a conventional airplane, a rotary wing aircraft, an airship or the like, which uses the hydrogen, in particular, as fuel or propellant to drive one or more main, auxiliary or secondary engines. The drive of the aircraft can be, in particular, a hydrogen combustion engine, a gas turbine, or a fuel cell with a downstream electric motor.

The invention also encompasses combinations of the features of the described embodiments. Therefore, the invention also encompasses realizations, which each comprise a combination of the features of several of the described embodiments, provided that the embodiments have not been described as mutually exclusive.

### BRIEF DESCRIPTION OF THE DRAWING FIGURES

Further advantageous developments of the present invention emerge from the dependent claims and the following description of preferred embodiments, wherein:

FIG. 1 is a schematic view of an embodiment of a fuel system according to the invention; and

FIG. 2 is a schematic view of an embodiment of an aircraft according to the invention.

### DESCRIPTION OF THE INVENTION

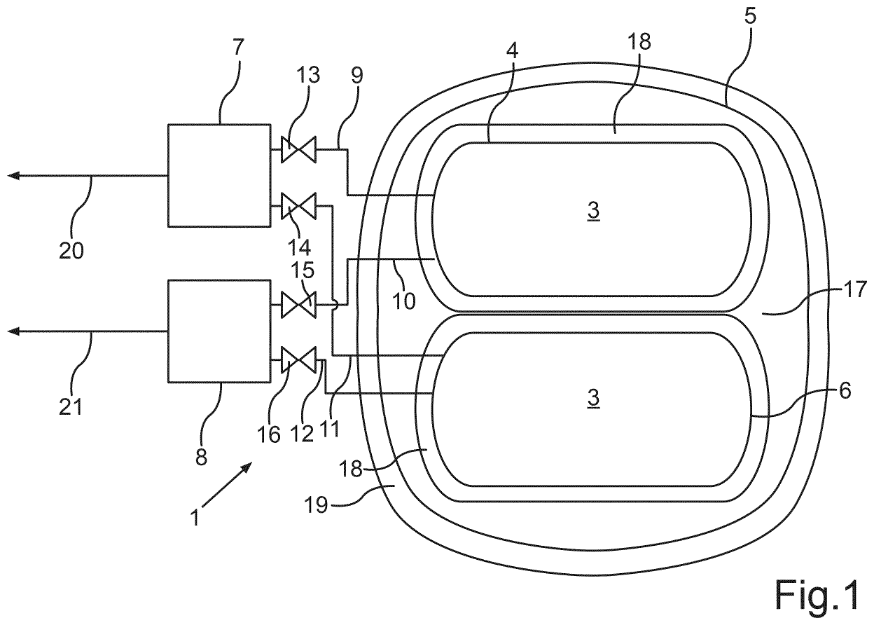

FIG. 1 shows a schematic representation of an embodiment of a fuel system 1 according to the invention for supplying an aircraft 2 with hydrogen 3. In this embodiment, the hydrogen 3 can be stored cryogenically in a first inner tank 4 and a second inner tank 6, which can be fluidically separated from another. The two redundant inner tanks 4, 6 can be surrounded in particular by a common outer tank 5. An intermediate space 17 can be formed between the outer tank 5 and the inner tanks 4, 6, which is preferably evacuated. This implies that a technical vacuum can prevail in the intermediate space 17. The outer tank 5 can accordingly be bulge-stable and designed to be able to hold a vacuum.

The first inner tank 4 can be fluidically connected to a first supply device 7 for supplying the aircraft 2 with hydrogen 3 via a first channel 9 for transporting the hydrogen 3. Additionally, the first inner tank 4 can be fluidically connected to the second supply device 8 for supplying the aircraft 2 with hydrogen 3 via a second channel 10, which is separate from the first channel 9, for transporting the hydrogen 3.

The second inner tank 6 can be fluidically connected to the first supply device 7 via a third channel 11 for transporting the hydrogen 3. Additionally, the second inner tank 6 can be fluidically connected to the second supply device 8 via a fourth channel 12, which is separate from the third channel 11, for transporting the hydrogen 3.

The redundant supply devices 7, 8 can in particular comprise valves, heat exchangers, safety valves, and/or pipes, which can be designed redundantly, and are designed for conditioning of the cryogenic or liquid hydrogen 3 in the inner tanks 4, 6 to the necessary operating conditions. For example, the first supply device 7 can supply the aircraft 2 with gaseous hydrogen 3 via a first supply line 20, and the second supply device 8 via a second supply line 21.

The channels 9, 10, 11, 12 may each comprise, for example, a separate shut-off valve 13, 14, 15, 16, which can fluidically separate or connect the respective channel 9, 10, 11, 12. The shut-off valves 13, 14, 15, 16 can also be integrated into the supply devices 7, 8.

In one embodiment, the inner tanks 4, 6 can each comprise a first insulation layer 18 for thermal insulation. This can be formed, for example, as MLI. The outer tank 5 can furthermore also comprise a second insulation layer 19 for thermal insulation inside or outside the vacuum-holding shell of the outer tank 5.

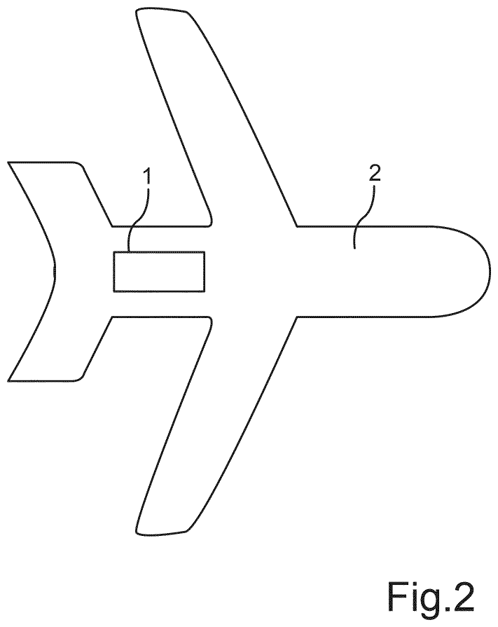

In FIG. 2, a schematic representation of an embodiment of an aircraft 2 according to the invention is shown. The aircraft 2 is merely shown as an example as a conventional airplane. Likewise, the placement of the fuel system 1 of the aircraft 2 is chosen arbitrarily and not limited to this position.

Overall, the examples show how a dual-channel for hydrogen tanks (inner tanks 4, 6) can be formed. Due to the low temperatures (storage temperature of approximately −253° C.) of cryogenic liquid hydrogen (LH2), LH2 tanks 4, 6 require very efficient insulation. In addition to insulation 18 on the surface of the tanks 4, 6, a design with a vacuum shell (vacuum jacket) can be implemented. The vacuum tank consists of an inner tank 4, 6 and an outer tank 5 (vacuum in the intermediate space 17) and comprises a high insulating effect. The cryogenic hydrogen is located in the inner tank 4, 6, which can withstand an overpressure inside the tank according to the operating conditions. The outer tank 5 is bulge-stable and can hold the vacuum. To achieve, for example, a dual channel of the fuel system 1 (redundancy of the fuel supply to minimize the probability of failure) with optimized space utilization, a double tank (two separate inner tanks 4, 6 for storage of LH2) can be integrated into a common surrounding vacuum shell 5 (for insulation). The advantage over two separate vacuum tanks (each tank having its own vacuum shell) is, on the one hand, a reduction in the required space, and on the other hand, a reduction in the mass of the necessary vacuum shell. At the same time, the separation of the two inner tanks 4, 6 guarantees a dual channel of the fuel supply—in the event of failure of one inner tank 4, 6, the other inner tank 4, 6 guarantees half of the range. The design can comprise the following behavior in the event of a failure:
Failure of outer tank (vacuum insulation defective): The second insulation made of multilayer or foam (on the inner tank 4, 6 or outer tank 5) can prevent strong heat input and thus higher evaporation of the LH2 in the tank 5 than is drawn by the consumer (consumptive device).
Failure of one inner tank (leakage): In the event of a loss of one inner tank 4, 6, the other inner tank 4, 6 can still be fully functional, so that in the event of a failure, only the range is reduced. The leakage in the inner tank 4, 6 can result in an outflow of the LH2 and evaporation; however, the intact insulation of the outer tank 5 can prevent further excessive evaporation of the outflowing LH2; the outer tank 5 can be pressurized with the internal pressure of the inner tank 4, 6.

Essentially, in a dual-channel LH2 system, the two LH2 tanks 4, 6 must not communicate with each other, but comprise independent extraction systems. Thus, in the event of a failure, half of the range can still be guaranteed, and a single inner tank 4, 6 can absorb any single failure of the other tank 4, 6 and the outer shell 5.

Analogous to the dual channel of the inner tanks 4, 6, a dual channel of the supply device 7, 8 is also implemented. Thus, malfunction of one supply capsule 7, 8 can also be absorbed by the other supply device 7, 8. By means of a suitable system architecture, a large number of potential errors can be absorbed—the failure of one inner tank 4, 6 and one supply device 7, 8 can be compensated (cross connections possible), see table:

| | Failure | Failure | Failure | Failure |
|---|---|---|---|---|
| | of first | of second | of first | of second |
| | inner | inner | supply | supply |
| | tank 4 | tank 6 | device 7 | device 8 |
| Error | x | | | |
| possibility | | x | | |
| | | | x | |
| | | | | x |
| | x | | x | |
| | | x | | x |
| | | x | x | |
| | x | | | x |

1. Fuel system for supplying an aircraft with hydrogen, comprising:
a first inner tank for storing hydrogen, and
an outer tank,
a second inner tank for storing hydrogen, which is fluidically separated from the first inner tank,
wherein the first inner tank and the second inner tank are stored inside the outer tank, and
wherein the first inner tank and the second inner tank separately from each other are fluidically connected to a first supply device of the fuel system for supplying the aircraft with hydrogen.

2. The fuel system according to claim 1, further comprising:
a second supply device for supplying the aircraft with hydrogen, wherein the first inner tank and the second inner tank separately from each other are fluidically connected to the second supply device.

3. The fuel system according to claim 2, wherein the first inner tank is fluidically connected to the first supply device via a first channel and to the second supply device via a separate second channel, and/or the second inner tank is fluidically connected to the first supply device via a third channel and to the second supply device via a separate fourth channel.

4. The fuel system according to claim 3, wherein the first supply device comprises a first shut-off valve for fluidically separating or connecting the first channel and/or a second shut-off valve for fluidically separating or connecting the second channel, and/or the second supply device comprises a third shut-off valve for fluidically separating or connecting the third channel and/or a fourth shut-off valve for fluidically separating or connecting the fourth channel.

5. The fuel system according to claim 1, wherein an intermediate space between the outer tank and the first inner tank and the second inner tank is evacuated.

6. The fuel system according to claim 1, wherein the first inner tank and/or the second inner tank comprises a first insulation layer.

7. The fuel system according to claim 1, wherein the outer tank comprises a second insulation layer.

8. The fuel system according to claim 1, wherein the first inner tank and/or the second inner tank are configured and arranged to store hydrogen cryogenically.

9. The fuel system according to claim 1, wherein the first inner tank and/or the second inner tank are designed are configured and arranged modularly and the outer tank can be opened reversibly, so that the first inner tank and/or the second inner tank can be exchanged.

10. The fuel system according to claim 1, wherein the first supply device and/or the second supply device configured and arranged to extract liquid hydrogen from the first inner tank and/or from the second inner tank.

11. The fuel system according to claim 1, further comprising:
a sensor device, which is configured and arranged to detect a disruption of the first inner tank and/or the second inner tank and/or the outer tank.

12. The fuel system according to claim 11, wherein the sensor device is configured and arranged to detect a disruption of the first supply device and/or the second supply device.

13. A method for operating the fuel system according to claim 1, comprising the steps of:
supplying the aircraft with hydrogen from the first inner tank in the event of a disruption of the second inner tank, or
supplying the aircraft with hydrogen from the second inner tank in the event of a disruption of the first inner tank.

14. The method according to claim 13, further comprising the steps of:
supplying the aircraft with hydrogen via the first supply device in the event of a disruption of the second supply device, or
supplying the aircraft with hydrogen via the second supply device in the event of a disruption of the first supply device.

15. An aircraft comprising the fuel system according claim 1.
